(19) United States
(12) Patent Application Publication
(10) Pub. No.: US 2025/0356517 A1
(43) Pub. Date: Nov. 20, 2025

(54) Material Density Estimation

(71) Applicant: Stereolabs SAS, Montrouge (FR)

(72) Inventors: Cecile Schmollgruber, Boulogne (FR); Edwin Azzam, Antony (FR); Olivier Braun, Vanves (FR); Aymeric Dujardin, Montrouge (FR)

(21) Appl. No.: 19/206,515

(22) Filed: May 13, 2025

Related U.S. Application Data
(60) Provisional application No. 63/647,605, filed on May 14, 2024.

(51) Int. Cl. G06T 7/60; G06T 7/00; G06V 10/25; G06V 20/70

(52) U.S. Cl. CPC G06T 7/60; G06T 7/97; G06V 10/25; G06V 20/70; G06T 2207/10028; G06T 2207/30188

(57) ABSTRACT

Systems and methods related to performing material density estimates are disclosed herein. A stereo imaging system may include a stereo camera and one or more processors. The stereo imaging system may capture a point cloud using the stereo camera, determine a region of interest using the point cloud, differentiate material components from a two-dimensional image to produce a filter, produce a filtered point cloud by (i) filtering the point cloud using the filter; and (ii) excluding points from the point cloud using the region of interest, and generate a material density estimate, for the material components, using the filtered point cloud. The material density estimate may allow the system to perform appropriate actions. For example, the material density estimate may allow the system to spray an appropriate amount of chemical on crops, reducing detrimental environmental effects, reducing costs, and improving yields.

### CROSS REFERENCE TO RELATED APPLICATIONS

This application claims the benefit of U.S. Provisional Patent Application No. 63/647,605, filed May 14, 2024, which is incorporated by reference herein in its entirety for all purposes.

### BACKGROUND

The present description relates to smart spraying in the case of agricultural land. Smart spraying technology uses sensors, automation, and data analytics to optimize the application of pesticides and fertilizers. Unlike traditional sprayers that apply chemicals uniformly across entire fields, smart sprayers use technology to detect the size, location, and density of individual trees or vines, adjusting spray volumes accordingly. This targeted approach reduces chemical use, minimizes spray drift and runoff, and lowers costs and environmental impact. Key features include precision targeting, automation, and data integration. For example, sensors may scan plants, ensuring chemicals are only applied where needed, reducing waste and exposure. Some systems can operate autonomously, following pre-set paths and adjusting in real time, which improves efficiency and reduces labor needs. These technologies are increasingly adopted due to their benefits for sustainability, regulatory compliance, and operational efficiency, making them a significant advancement in modern agricultural management.

Smart spraying systems face several challenges in accurately detecting foliage density and thus detecting how much chemical to use in a given spot. For example, LiDAR struggles with signal attenuation in dense/multilayered foliage, reducing data accuracy. Ultrasonic sensors and spectral analysis likewise may be prone to errors. Irregular leaf distribution and growth stages create non-uniform density patterns that challenge real-time detection and spray adjustments. If too much chemical is used, then there may be adverse environmental effects and increased costs. If too little chemical is used, then the chemical may be less effective, reducing yields. These limitations highlight the need for improved sensor fusion and adaptive algorithms to handle diverse field conditions.

### SUMMARY

This disclosure relates to estimating material density. Embodiments in this disclosure relate to the field of smart spraying in agriculture (e.g., orchards or vineyards). In sophisticated sprayers, each nozzle can be controlled separately; however, the lack of information regarding the surroundings may lead to the nozzles being constantly fully opened, even if there is not a anything to spray nearby (e.g., a tree). If information regarding the surroundings overestimates the foliage density, then the system may likewise overestimate the amount of chemical to spray. Over-spraying chemicals has at least two drawbacks. The first drawback is environmental, because the spraying of extra chemicals (e.g., herbicides, pesticides, fertilizers) may lead to detrimental environmental effects. The second drawback is financial as the chemicals may be expensive. Some systems may inaccurately detect too little foliage. If a system underestimates the amount of chemical needed, then the chemical may be less effective, reducing yields.

The perfect scenario would be to deliver the appropriate amount of chemicals to each plant. This requires two different pieces of knowledge; first it requires correctly identifying the appropriate biomaterial. This may include identifying the plant and specifically its foliage (as major spraying task may be related to the foliage). This first task of being able to identify and measure the biomass (e.g., tree) is a robotic perception task. Second, delivering the appropriate amount of chemicals to each plant requires estimating the correct amount of chemicals needed. This second task requires agrotechnical knowledge to determine, based on both the season and the foliage aspect, what the plant needs. Solving the first task will reduce the waste of chemicals by turning off the nozzle if there are no plants (e.g., trees in the orchard) nearby. Solving the second task will provide the appropriate quantity of chemicals and, in most scenarios, will deliver a smaller quantity also leading to chemicals savings.

Accurate material (e.g., foliage) density estimation for adjusting chemical spray nozzles may include a point cloud, a semantic detector, and a point cloud filter. For example, an estimation system may use a point cloud estimation based on a stereo camera and projection in the world reference frame. In specific embodiments, the system may convert the point cloud to a height map (e.g., 2.5D map) to determine the foliage localization and the region of interest. In specific embodiments, the system may use other techniques to find the 3D region of interest. The system may use a semantic detector to differentiate objects including portions of a tree (e.g., leaf, trunk, branch, petiole). The system may filter the 3D point cloud, only keeping points that are leaves or petioles and removing points that are not in the region of interest. In specific embodiments, the system may project the point cloud into a voxel map on the 3D region of interest. To determine a percentage of density of the foliage (e.g., leaf/branches), the system may count the number of occupied voxels vs empty voxels. In specific embodiments, the system may create a density map of the environment by combining density information with localization information (e.g., GPS or visual tracking). In specific embodiments, the system may send a control signal to perform an action (e.g., variable spraying amount and direction, ON/OFF on an agricultural implement) based on determined foliage density.

In specific embodiments of the invention, a computer-implemented method is provided. The method comprises capturing a point cloud using a stereo camera, determining a region of interest using the point cloud, and differentiating, using a semantic detector, material components from a two-dimensional image to produce a filter. The method also comprises producing a filtered point cloud by: filtering the point cloud using the filter; and excluding points from the point cloud using the region of interest. The method also comprises generating a material density estimate, for the material components, using the filtered point cloud.

In specific embodiments of the invention, one or more non-transitory computer-readable media is provided. The one or more non-transitory computer-readable media store instructions that, when executed by one or more processors, cause the one or more processors to conduct a method. The method comprises: capturing a point cloud using a stereo camera, determining a region of interest using the point cloud, and differentiating, using a semantic detector, material components from a two-dimensional image to produce a filter. The method also comprises producing a filtered point cloud by: filtering the point cloud using the filter; and excluding points from the point cloud using the region of interest. The method also comprises generating a material density estimate, for the material components, using the filtered point cloud.

In specific embodiments of the invention, a stereo imaging system for detecting physical objects is provided. The stereo imaging system comprises: a pair of imagers, one or more processors, and one or more non-transitory computer-readable media storing instructions that, when executed by the one or more processors, cause the stereo imaging system to conduct a method. The method comprises: capturing a point cloud using a stereo camera, determining a region of interest using the point cloud, and differentiating, using a semantic detector, material components from a two-dimensional image to produce a filter. The method also comprises producing a filtered point cloud by: filtering the point cloud using the filter; and excluding points from the point cloud using the region of interest. The method also comprises generating a material density estimate, for the material components, using the filtered point cloud.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a flowchart for generating a material density estimate for material components in accordance with specific embodiments of the inventions disclosed herein.

FIG. 2 provides an example of a flowchart for creating a density map for material components in accordance with specific embodiments of the inventions disclosed herein.

FIG. 3 provides examples of stereo camera placements on a vehicle in accordance with specific embodiments of the inventions disclosed herein.

FIG. 4 provides examples of steps for performing a material density estimate based on a point cloud in accordance with specific embodiments of the inventions disclosed herein.

FIG. 5 provides examples of determining a region of interest in accordance with specific embodiments of the inventions disclosed herein.

FIG. 6 provides an example of differentiating region of interest components in accordance with specific embodiments of the inventions disclosed herein.

FIG. 7 provides an example of determining a region of interest using a height map in accordance with specific embodiments of the inventions disclosed herein.

FIG. 8 provides an example of a density map of a field of crops in accordance with specific embodiments of the inventions disclosed herein.

FIG. 9 provides an example of a method for generating a material density estimate in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for material density estimation in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Agricultural smart spraying may use controllable nozzles mounted on a vehicle to automatically spray chemicals such as pesticides, herbicides, and fertilizers. Even though, in some systems, nozzles can be controlled separately, a lack of accurate information regarding the surroundings may cause waste and other inefficiencies. A lack of information regarding the surroundings may, in some cases, cause the nozzles to be opened too much at the wrong locations, resulting in chemical waste, environmental issues, and increased costs. A lack of accurate information regarding the surroundings may also, in other cases, cause the nozzles to be closed too much at the wrong locations, resulting in decreased yields, wasted time, and resource losses.

The ideal scenario would be to deliver the appropriate amount of chemicals to each plant. This requires identifying the appropriate biomaterial (e.g., foliage), estimating the amount of that biomaterial, and estimating the amount of chemicals needed for that estimated amount of biomaterial. Identifying and measuring the biomass may be a robotic perception task. Estimating and delivering the appropriate amount of chemicals to each plant may require agrotechnical knowledge to determine, based on both the season and the foliage aspect, what the plant needs. This agricultural knowledge may be part of a trained artificial intelligence that may use semantic filters, daylight logs, weather sensors, historical data, etc. Some smart sprayers may connect to digital platforms, allowing real-time monitoring, record-keeping, and further optimization of crop management.

Accurate material (e.g., foliage) density estimation for adjusting chemical spray nozzles may include a point cloud, a semantic detector, and a point cloud filter. For example, an estimation system may use a point cloud estimation based on a stereo camera and projection in the world reference frame. In specific embodiments, the system may convert the point cloud to a height map (e.g., 2.5D map) to determine the foliage localization and the region of interest. In specific embodiments, the system may use other techniques to find the 3D region of interest. The system may use a semantic detector to differentiate objects including portions of a crop plant (e.g., leaf, trunk, branch, petiole). The system may filter the 3D point cloud, only keeping points that are leaves or petioles and removing points that are not in the region of interest. In specific embodiments, the system may project the point cloud into a voxel map on the 3D region of interest. To determine a percentage of density of the foliage (e.g., leaf/branches), the system may count the number of occupied voxels vs empty voxels. In specific embodiments, the system may create a density map of the environment by combining density information with localization information (e.g., GPS or visual tracking). In specific embodiments, the system may send a control signal to perform an action (e.g., variable spraying, ON/OFF on an agricultural implement) based on determined foliage density.

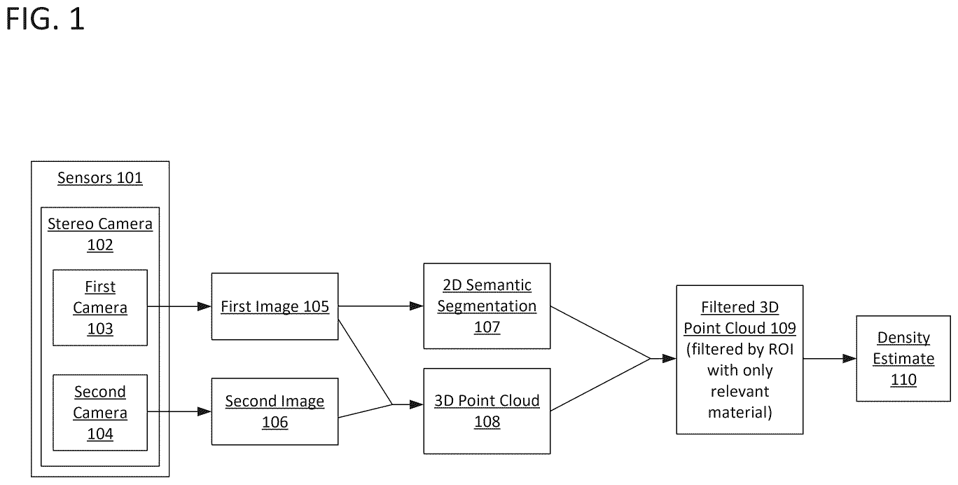

FIG. 1 provides an example flowchart for generating a material density estimate for material components in accordance with specific embodiments of the inventions disclosed herein. As an example, the material components may be leaves and petioles and the material density estimate may be a foliage density estimate (e.g., excluding branches, trunks, ground cover, etc.). The foliage density estimate may be used to determine how much chemical (e.g., herbicide, pesticide) to spray onto the foliage at a certain location.

A stereo camera system may include sensors 101, one or more processors for analyzing data from sensors 101, and one or more non-transitory computer-readable media storing instructions for analyzing the data. Sensors 101 may include stereo camera 102. In specific embodiments, sensors 101 may include additional sensors. Stereo camera 102 may include first camera 103 (e.g., a left camera) and second camera 104 (e.g., a right camera).

First camera 103 of stereo camera 102 may capture first image 105 (e.g., a left image). Second camera 104 of stereo camera 102 may capture second image 106 (e.g., a right image). First image 105 and second image 106 may each be two-dimensional (2D). First camera 103 and second camera 104 may be mounted on the front of, on top of, or on the side of a vehicle that travels along navigation routes. As an example, stereo camera 102 may be mounted on a tractor with automated driving assistance features that drives in between trellises of a vineyard.

First image 105 may undergo 2D semantic segmentation 107. As part of 2D semantic segmentation 107, stereo camera system may differentiate, using a semantic detector, material components from a first image 105 to produce a semantic filter. The semantic detector may be specifically trained to recognize leaves, trunks, branches, stems, and petioles. In specific embodiments, the semantic filter may tag each pixel or pixel coordinate on first image 105 as a specific item or category of item such as a leaf, petiole, branch, stem, truck, fence post, wire, ground, fruit, pipe, rock, flower, etc. In specific embodiments, the semantic filter may tag each pixel or pixel coordinate on first image 105 as relevant material (e.g., leaf or petiole) or as nonrelevant material (e.g., branch, stem, truck). Relevant material may be kept when filtering point cloud 108 to make filtered point cloud 109. Leaves and petiole may be designated as relevant material as these may contribute to foliage and major spraying tasks may be related to the foliage. Other classifications may be designated as nonrelevant material as these may not contribute to foliage. The semantic filter may remove any points that do not belong to the crop. The semantic filter may be used to remove all the 3D points that are tagged as “other”, “stem”, etc. such that only foliage (e.g., leaves and petioles) remain. In specific embodiments, second image 106 may undergo 2D semantic segmentation instead of first image 105. In specific embodiments, first image 105 and second image 106 may both undergo 2D semantic segmentation and the segmentation with the highest confidence may be used in subsequent steps.

The stereo camera system may capture 3D point cloud 108 in camera space using stereo camera 102. For example, 3D point cloud 108 may be based on first image 105 and second image 106 captured by stereo camera 102. The stereo camera system may determine a region of interest (ROI) using 3D point cloud 108. The region of interest may define the 3D bounding box of the crops where the density estimate calculation will be made. In specific embodiments, the region of interest (e.g., zone of interest) may not be a contiguous volume but rather may be several disconnected volumes. For example, two trees that are spaced apart may be analyzed in the same 3D point cloud; the two trees may be part of the region of interest while the space between the two trees may not. The region of interest may be a collection of data rather than the physical space. For example, the region of interest may refer to specific portions of first image 105 or 3D point cloud 108 rather than the physical plants in the environment. The region of interest may be determined by a region of interest detector which may use semantic segmentation. In specific embodiments, the region of interest may be determined using 3D semantic segmentation of 3D point cloud 108. In specific embodiments, the region of interest may be determined by comparing entries of a 2.5D height map (based on 3D point cloud 108) to a threshold. In specific embodiments, the region of interest may be determined using 2D semantic segmentation based on first image 105 or second image 106. In specific embodiments, the region of interest may include a row of trees and may exclude the path between adjacent rows of trees. In specific embodiments, the region of interest may include the leafy portions of trees (e.g., not including the first few feet of tree height from the ground), the wires or posts of trellises supporting leafy vines (e.g., not including tall areas where the vines do not reach), or another region where living leaves are found. For example, the region of interest may refrain from including the ground despite the presence of (fallen) leaves. The stereo camera system may use the determined region of interest to make a region of interest filter to focus density estimate 110 on a relevant region of the environment captured by stereo camera 102.

The stereo camera system may produce filtered point cloud 109. The stereo camera system may produce filtered point cloud 109 by filtering point cloud 108 using the 2D semantic filter. This semantic filter may be used to remove all the 3D points that are tagged as “other”, “stem” such that only foliage points (e.g., leaves and petioles) remain. Since the semantic filter is based on the same 2D image 105 that 3D point cloud 108 is based on (the 2D points that correspond to the 3D points is already known), the unnecessary 3D points can be easily removed. Filtered point cloud 109 may also be filtered by excluding points from point cloud 108 using the ROI filter based on the region of interest. For example, any points of 3D point cloud 108 that are not within the box defined by the region of interest may be removed in point cloud 109. The region of interest may be a collection of data rather than the physical space. For example, the region of interest may refer to specific portions of first image 105 or 3D point cloud 108 rather than the physical plants in the environment.

The stereo imaging system may generate material density estimate 110, for the material components, using filtered point cloud 109. As an example, the material components may be leaves and petioles and the material density estimate may be a foliage density estimate (e.g., excluding branches, trunks, ground cover, etc.). The foliage density estimate may be used to determine how much chemical (e.g., herbicide, pesticide) to spray at the corresponding location. Accordingly, the foliage density estimate may trigger a signal to an actuator such as a nozzle. The spray location may be in camera coordinates or world coordinates. In specific embodiments, multiple density estimations may form a density estimation map.

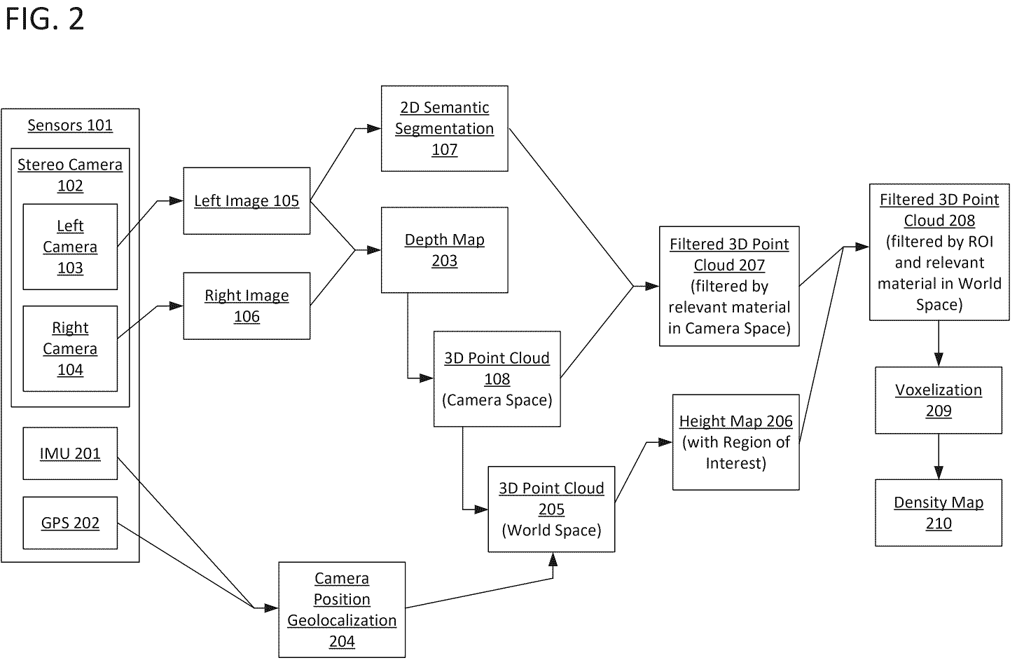

FIG. 2 provides an example flowchart for creating a density map for material components in accordance with specific embodiments of the inventions disclosed herein. As an example, the material components may be leaves and petioles and the material density estimate may be a foliage density estimate (e.g., excluding branches, trunks, ground cover, stems, etc.). The foliage density estimate may be used to determine how much chemical (e.g., herbicide, pesticide) to spray at a certain location of the foliage.

A stereo camera system (e.g., stereo imaging system) may include sensors 101, one or more processors for analyzing data from sensors 101, and one or more non-transitory computer-readable media storing instructions for analyzing the data. Sensors 101 may include stereo camera 102, inertial measurement unit (IMU) 201, and global positioning system (GPS) 202. In specific embodiments, sensors 101 may include additional sensors.

First camera 103 of stereo camera 102 may capture first image 105 (e.g., a left image). Second camera 104 of stereo camera 102 may capture second image 106 (e.g., a right image). First image 105 and second image 106 may each be 2D. IMU 201 and GPS 202 may obtain localization information about the stereo imaging system in world coordinates.

First image 105 may undergo 2D semantic segmentation 107. As part of 2D semantic segmentation 107, stereo camera system may differentiate, using a semantic detector, material components from a first image 105 to produce a semantic filter. The semantic detector may be specifically trained to recognize leaves, trunks, branches, stems, and petioles. The semantic filter may tag each pixel or pixel coordinate on first image 105 as a specific item, a specific category of item, or as relevant/nonrelevant material. Leaves and petiole may be designated as relevant material as these may contribute to foliage and major spraying tasks may be related to the foliage.

The stereo camera system may use first image 105 and second image 106 to compute depth map 203. The stereo camera system may capture 3D point cloud 108 in camera space using stereo camera 102. For example, 3D point cloud 108 may be based on depth map 203, which may be based on first image 105 and second image 106 captured by stereo camera 102.

The stereo camera system may determine camera position geolocation 204 using IMU 201, GPS 202, or both. The stereo camera system may generate 3D point cloud 205 in world space (e.g., using world coordinates). 3D point cloud 205 may be a transformation of the coordinates of 3D point cloud 108 according to the following equation:

$$[ \begin{matrix}{X}_{c} \\ {Y}_{c} \\ {Z}_{c} \\ 1\end{matrix} ] = [ \begin{matrix}{r}_{11} & {r}_{12} & {r}_{13} & {t}_{z} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}{X}_{w} \\ {Y}_{w} \\ {Z}_{w} \\ 1\end{matrix} ] .$$

Variables (Xw, Yw, Zw) are the 3D point coordinates extracted from the camera (e.g., in the camera reference frame) in accordance with 3D point cloud 108. Variables r and t refer to the position of the camera in the world frame. Variables (Xc, Yc, Zc) are the coordinates of the 3D points in the world reference frame, which then make up point cloud 205. Using 3D points in the world reference frame (e.g., rather than the camera frame) may make it easier to determine height map 206 and detect a region of interest in the world (e.g., the crops).

The stereo camera system may generate height map 206 to select a region of interest (ROI). Height map 206 may be a 2.5D height map and may be based on 3D point cloud 205. The stereo camera system may determine a region of interest (ROI) using 3D point cloud 108. The region of interest may define the 3D bounding box of the crops where the density estimate calculation will be made. In specific embodiments, the region of interest may not be a contiguous volume but rather may be several disconnected volumes. The region of interest may refer to specific portions of first image 105 or 3D point cloud 108 rather than the physical plants in the environment. In specific embodiments, the region of interest may be determined by height map 206 in combination with a region of interest detector which may use semantic segmentation. In specific embodiments, the region of interest may be determined by height map 206 in combination with a height threshold. The height threshold may be used to determine where the crops are (e.g., height>threshold) and where the navigation rows are (e.g., height<threshold). For example, the region of interest may exclude areas below a minimum height such that bare ground (e.g., of navigation rows) is excluded. As another example, the region of interest may include the upper leafy portions of trees (e.g., not including the first few feet of tree height from the ground, where there may be little to no foliage). The stereo camera system may use the determined region of interest to make a region of interest filter to focus density estimate 110 on a relevant region of the environment captured by stereo camera 102. In specific embodiments, the region of interest may be determined via height map before semantic segmentation is performed. In this case, the semantic segmentation may be performed only within the region of interest, reducing the computing time and power of the system. In specific embodiments, the region of interest may be determined via both height map and semantic segmentation.

The stereo camera system may produce filtered 3D point cloud 207. The stereo camera system may produce filtered 3D point cloud 207 by filtering point cloud 108 using the 2D semantic filter (e.g., produced during 2D semantic segmentation 107). Points that are not relevant to the material density estimation may be removed. For example, points labeled as “other” or “stem” may be removed while points labeled as “leaf” and “petiole” may be kept in filtered 3D point cloud 207.

The stereo camera system may generate filtered point cloud 208 by excluding points from filtered 3D point cloud 207 using the ROI filter based on the region of interest. For example, any points of 3D point cloud 207 that are not within the bounding box defining the region of interest may be removed from point cloud 207 to make point cloud 208. As height map 206 may be in world space, filtered 3D point cloud may also be in world space. The region of interest may be a collection of data rather than the physical space. For example, the region of interest may refer to specific portions of first image 105 or 3D point cloud 207 rather than the physical plants in the environment.

The stereo imaging system may perform voxelization 209 on filtered point cloud 208. The region of interest may be transformed into a grid map or a voxel map. The 3D space may be separated into small cubes (or other shapes such as parallelepipeds) of known dimensions to create a grid. 3D point cloud 208 may be projected onto this grid map. Depending on the number of points in a single voxel, a level of density is calculated for each voxel. Based on the resolution of the point cloud and the size of the voxel (e.g., cell), a maximum value of point for a voxel can be calculated. The level of density (LoD) for each voxel may be: LoD=100*N (point)/Nmax, where N (point) is the number of point cloud data points from point cloud 208 within that voxel and Nmax is the number of point cloud data points within the voxel with the most point cloud data points from point cloud 208.

Material density map 210 may include material density estimates for each pixel, voxel, or other unit of area or volume. The stereo imaging system may generate material density map 210, for the material components, using voxelization 209 of filtered point cloud 208. In specific embodiments, material density map 210 may be generated from filtered 3D point cloud 208, as voxelization 209 may be skipped. In specific embodiments, the material components may be leaves and petioles and the material density map may be a foliage density map (e.g., excluding branches, trunks, ground cover, stems, etc.). In specific embodiments, the material components and material density estimate may relate to all biomass matter including twigs, trunks, boxes, or anything that gives a yield estimate (e.g., flowers, fruits). The foliage density map may be used to determine how much chemical (e.g., herbicide, pesticide) to spray at the corresponding location.

In specific embodiments, some voxels may be detected where no data can be captured. In this case, ray casting methods may be used to determine if a point can be seen. The distinction between voxels where data cannot be captured vs voxels where data is zero (e.g., no foliage data points because there is no foliage) may be important when calculating the density of the crop. For example, voxels where data cannot be captured (e.g., occluded forest voxels) may be removed from the density calculation rather than counting as voxels with zero foliage. An average density level may be computed for the specific region of interest: Density=SUM(Vdensity)/100×Nvoxels, where Vdensity is the density of each voxel in the region of interest and Nvoxels is the number of voxels in the region of interest (e.g., excluding voxels where data cannot be gathered). By combining a geolocalization position given by GPS 202 or another positioning system, the density may be logged for each position and filter to obtain a density map of the environment (e.g., field, orchard, vineyard).

In the example of FIG. 2, density map 210 is in world space; however, a density map may also be in camera space. If the density map is not in world space, then IMU 201 and GPS 202 may be omitted from sensors 101; additionally, camera position geolocation 204 and 3D point cloud 205 may be skipped. Height map 206 may be based on 3D point cloud 108 in camera space. Filtered 3D point cloud 208 and voxelization 209 may also be in camera space.

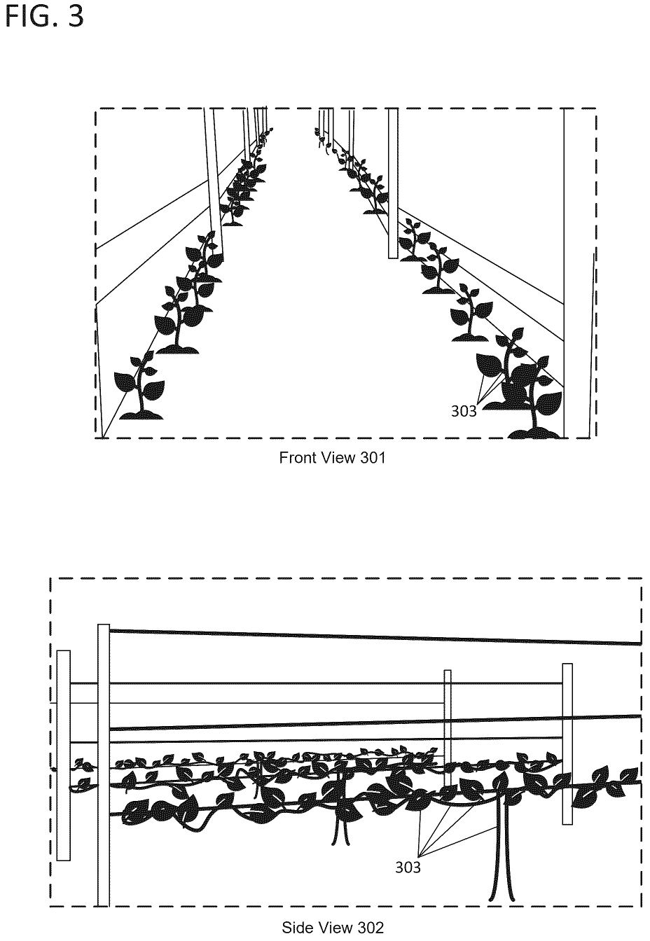

FIG. 3 provides an example of stereo camera placements on a vehicle in accordance with specific embodiments of the inventions disclosed herein. The stereo camera may be placed at a location where it can see the plants, crops, or rows to determine the foliage density (e.g., or other material density). As illustrated, material components 303 may refer to leaves, petioles, stems, trunks, and vines. Material components may refer to a variety of objects and materials. In specific embodiments, material components may refer to foliage components (e.g., leaves and petioles but not stems).

The stereo camera may be connected to a compute unit to perform part or all of the foliage density estimation. Front view 301 shows the point of view of an imager of the stereo camera where the stereo camera is mounted on the front of a vehicle such as a tractor or truck in an orchard. Alternatively, the camera may be mounted on the top of the vehicle and facing forward to produce front view 301. Side view 302 shows the point of view of an imager of the stereo camera where the stereo camera is mounted on the side of a vehicle such as a tractor or truck in a vineyard. In both cases, the vehicle may move along rows of plants and may spray chemicals such as herbicides, pesticides, and fertilizers. By using foliage density estimate and estimation maps, chemicals may be sprayed while minimizing chemical costs, minimizing environmental effects, and maximizing effectiveness.

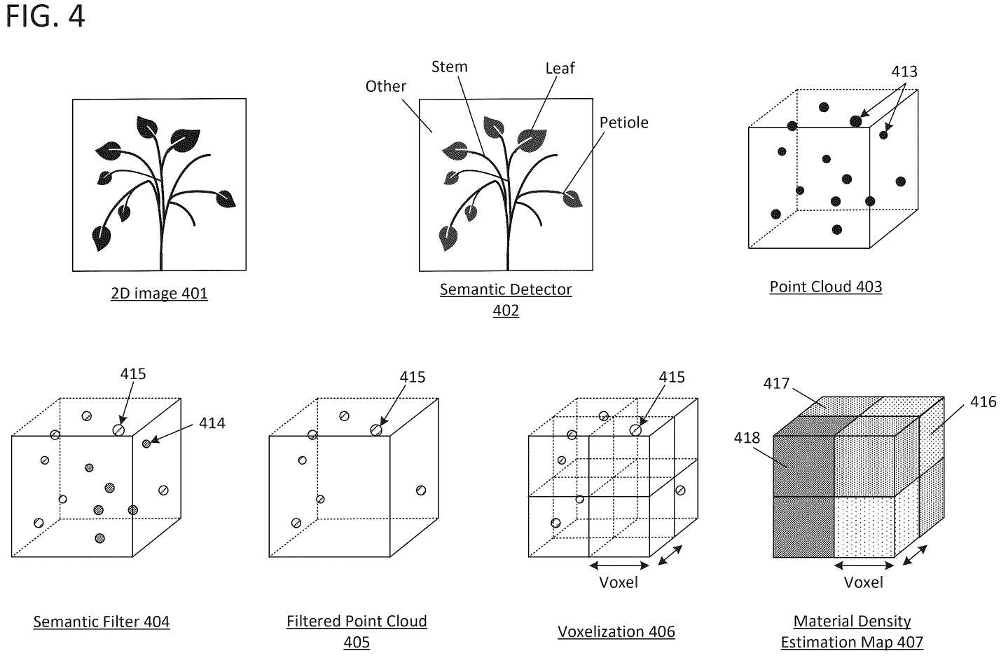

FIG. 4 provides examples of steps for performing a material density estimate based on a point cloud in accordance with specific embodiments of the inventions disclosed herein. The material components of the material density estimate may be foliage components, and the material density estimate may be a foliage density estimate. Aspects of FIG. 4 are for illustrative purposes and may be altered. For example, voxelization 406 divides the region of filtered point cloud 405 into eight voxels; however, any number of voxels may be used. As another example, the quantity of illustrated point cloud data points is reduced for clarity where the system may actually acquire more point cloud data points for analysis. Additionally, 2D image 401 shows one plant; however, a 2D image may include multiple plants, portions of plants, reference surfaces (e.g., the ground), and other objects (boxes, fences, etc.).

A stereo imaging system may capture 2D image 401 using an imager of a stereo camera. The stereo camera system may differentiate, using semantic detector 402, material components from 2D image 401. Semantic detector 402 may identify components of 2D image 401 as leaves, petioles, and stems. In alternative examples, a semantic detector may identify components of a 2D image as relevant material components (e.g., leaves and petioles) and non-relevant material components (e.g., stems). Relevant material components may be those components that contribute to foliage density.

The stereo imaging system may capture point cloud 403 using the stereo camera. Point cloud 403 may be a 3D point cloud and may be based on 2D image 401 as well as the 2D image captured by the other imager in the stereo camera. Point cloud 403 may include point cloud data points 413 at coordinates (e.g., camera coordinates, world coordinates) that correspond to physical surfaces. In specific embodiments, point cloud 403 may be voxelated or organized into voxels.

The stereo camera system may produce semantic filter 404 based on semantic detector 402 and point cloud 403. The stereo camera system may label point cloud data points as “keep” or “disregard” based on the point cloud data points being relevant to foliage density or not. The stereo camera system may label coordinates of point cloud data points as “keep” or “disregard” based on the corresponding point cloud data points being relevant to foliage density or not. Point cloud data points 414 (e.g., relating to stems or “other”) may be marked to be filtered out while point cloud data points 415 (e.g., relating to leaves and petioles) may be marked to be kept in for filtered point cloud 405.

The stereo imaging system may produce filtered point cloud 405 using semantic filter 404 and point cloud 403. Filtered point cloud 405 may be produced by filtering point cloud 403 using semantic filter 404. In specific embodiments, filtered point cloud 405 may also exclude point cloud data points from point cloud 403 using a region of interest. The region of interest may determine which portions of a 2D image are relevant to the current task (e.g., spraying pesticide on foliage). The region of interest may be determined by using point cloud 403 or semantic detector 402. In the example of FIG. 2, the entire 2D image 401 and the entire point cloud 403 may be included in the region of interest.

Voxelization 406 may divide filtered point cloud 405 into voxels. The voxels may have known dimensions (e.g., 1 cm×1 cm×1 cm). The number of point cloud data points in a voxel is variable and depends on the environment. Some voxels may include multiple point cloud data points while other voxels may not include any point cloud data points (e.g., voxels may be empty).

The stereo camera system may use filtered point cloud 405 and voxelization 406 to generate one or more material density estimates. In specific embodiments, generating the material density estimate may use a voxel map of the region of interest. The material density estimate may relate to the material components such as leaves and petiole. Multiple material density estimates may be combined to make material density estimation map 407. Voxel 416 is an example of a voxel with little to no estimated foliage; voxel 417 is an example of a voxel with medium estimated foliage density; and voxel 418 is an example of a voxel with high estimated foliage density. Material density estimation map 407 may be in camera space. In specific embodiments, a material density estimation map may be in world coordinates. In specific embodiments, the material density estimates may have a voxel resolution. In specific embodiments, the density map may average material density estimates for multiple voxels to have a lower resolution. The resolution of the density map may be based on the current task and equipment. For example, the resolution of the density map may be based on the capabilities of the pesticide sprayer (e.g., spray diameter, spray distance, etc.) or of computing processors (e.g., sensor resolution, processing speed, etc.).

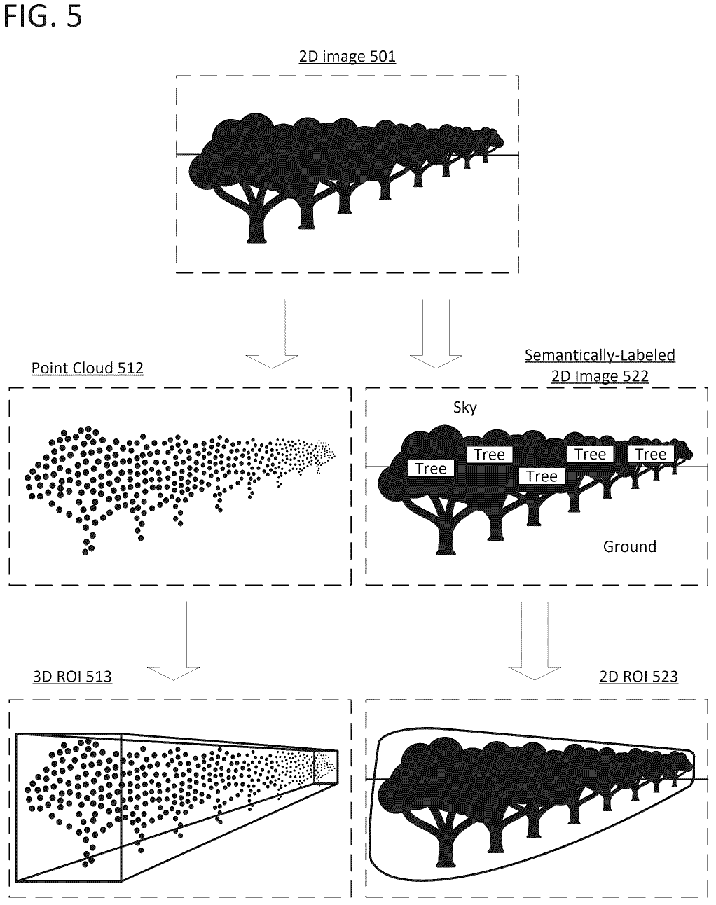

FIG. 5 provides examples of determining a region of interest in accordance with specific embodiments of the inventions disclosed herein. One method of determining a region of interest may be to use a point cloud. Another method of determining a region of interest may be to use a semantic filter. In specific embodiments, these methods may be combined.

The determining of the region of interest may include point cloud 512. A stereo imaging system may capture 2D image 501 using an imager. The stereo imaging system may also capture another 2D image using another imager and may use the two 2D images to create point cloud 512. In specific embodiments, point cloud 512 may be converted to a height map and determining 3D region of interest 513 may use the height map. In specific embodiments, using the height map may include determining where entries in the height map exceed a threshold. The stereo imaging system may generate a material density estimate using a voxel map of the region of interest. Although not shown, point cloud 512 may include point cloud data points organized in voxels. 3D region of interest 513 may also be organized in voxels.

The determining of the region of interest may include semantically-labeled 2D image 522. A stereo imaging system may capture 2D image 501 using an imager. A semantic detector (e.g., a region of interest detector) may label portions of 2D image 501 to create semantically labeled 2D image 522. In the example of FIG. 5, semantically-labeled 2D image 522 includes labels such as “Tree”, “Sky”, and “Ground.” Other semantically-labeled 2D images may include labels such as “Foliage” and “not Foliage.” Other semantically-labeled 2D images may include labels such as “relevant material” and “not relevant material”. Other semantically-labeled 2D images may include labels such as “leaf”, “petiole”, “stem”, “branch”, “trunk”, “rock”, “fence”, “box”, “hose”, “person”, “vehicle”, “animal”, etc. In the example of FIG. 5, the system may be interested in Trees while the ground and sky do not contribute to the region of interest. Accordingly, 2D region of interest 523 may capture the trees of semantically-labeled 2D image 522 while leaving out excess portions of “Sky” and “Ground.”

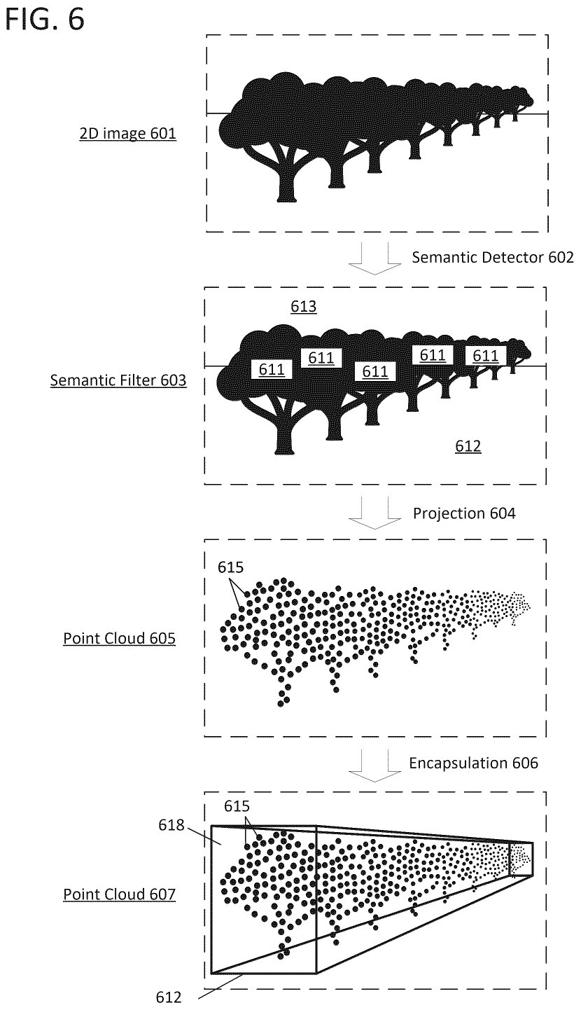

FIG. 6 provides an example of differentiating region of interest components in accordance with specific embodiments of the inventions disclosed herein. Region of interest components may be differentiated from components that are not part of the region of interest. In specific embodiments, region of interest components may be differentiated from other region of interest components. Region of interest components may be used, in the example of FIG. 6, to estimate foliage density for a row of trees in a field.

The stereo imaging system may differentiate region of interest components 611 from other components 612 and 613 in 2D image 601. The stereo imaging system may use semantic detector 602 to differentiate region of interest components 611, component 612, and component 613 to identify region of interest points and create semantic filter 603. Region of interest components 611 may refer to trees, component 612 may refer to the ground, and component 613 may refer to the sky. The ground and the sky may have no effect on foliage density and may be ignored for the foliage density estimation (e.g., removed via semantic filter 603). Portions of trees may contribute to foliage density and thus may be included in the region of interest (e.g., kept via semantic filter 603). In specific embodiments, the density of material components may refer to many types of biomass including twigs, tree trunks, flowers, fruits, leaves, petiole, etc. In specific embodiments, the density of material components may refer to leaves and petiole. The density of material components may refer to the volume of leaves per volume of space, volume of leaves per volume of branches, etc.

The stereo imaging system may project 604 region of interest points into point cloud 605 to produce a set of projected region of interest points 615. In specific embodiments, point cloud 605 may be organized into voxels.

The stereo imaging system may use the set of projected region of interest points 615 to determine region of interest 618 in point cloud 607. The stereo imaging system may encapsulate 606 the set of projected region of interest points 615 and may extend the region of interest 618 from the ground (e.g., component 612) up towards the set of projected region of interest points 615. Region of interest 618 may end at a height above which there are few or no projected region of interest points 615. For example, region of interest 618 may include all projected region of interest points 615 while excluding as much extra space (not containing to projected region of interest points 615) within its bounding box as possible. Although FIG. 6 shows an example of a contiguous region of interest, regions of interest may be noncontiguous. For example, two rows of trees may be within the field of view of the stereo camera. One row may be to the left and another row may be to the right, with a navigation row devoid of trees between them. In this case, each row of trees may form noncontiguous portions of the region of interest. In specific embodiments, multiple regions of interest may be part of a point cloud.

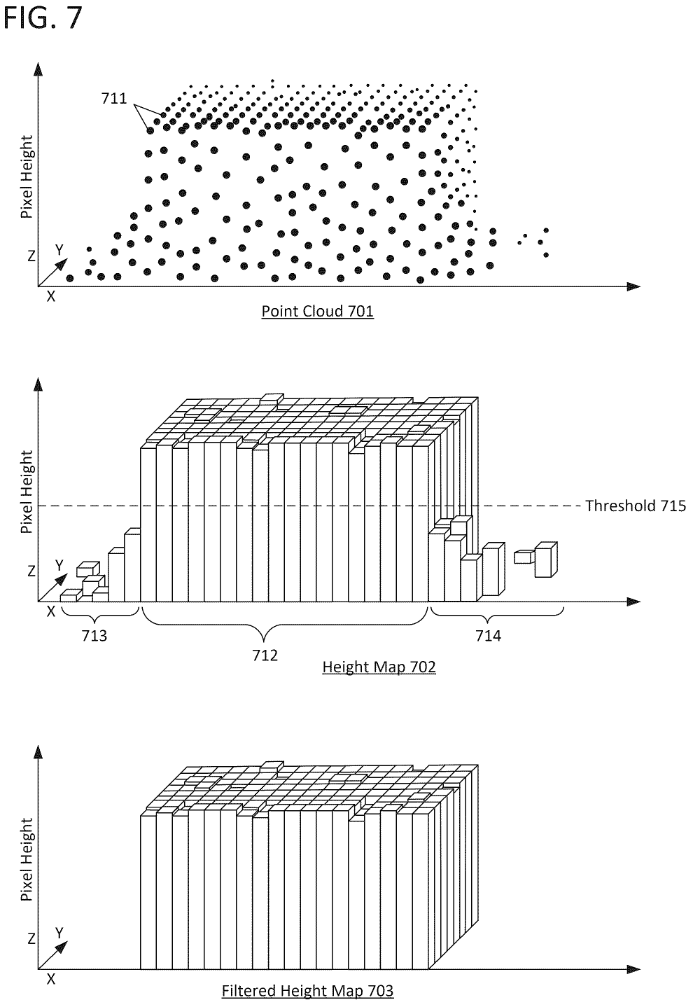

FIG. 7 provides an example of determining a region of interest using a height map in accordance with specific embodiments of the inventions disclosed herein. The height map may be used in combination with a height threshold to filter out point cloud data points. The height threshold may be used to determine where the crops are (e.g., height>threshold) and where the navigation rows are (e.g., height<threshold). For example, the region of interest may exclude areas below a minimum height such that bare ground (e.g., of a navigation row) is excluded.

A stereo imaging system may capture point cloud 701 with point cloud data points 711. Point cloud 701 may be organized into voxels or columns (e.g., within specific x- and y-coordinate intervals but not within specific z-coordinate intervals). The stereo imaging system may convert point cloud 701 to height map 702. Height map 702 may organize point cloud data points 711 into columns and may determine the height of those columns. The heights of the columns may be determined by determining filled vs empty voxels, by using confidence scores of point cloud data points 711, by determining a highest point cloud data point, or by another means.

The region of interest may include entries (e.g., heights of columns) in height map 702 that exceed a threshold. Entries in height map 702 may be compared to threshold 715. Region 712 may have entries that satisfy (e.g., that are above) threshold 715. Regions 713 and 714 may have entries that do not satisfy (e.g., that are equal to or below) threshold 715. Filtered height map 703 shows just the entries of height map 702 that satisfy threshold 715. The region of interest may be confined to region 712, corresponding with filtered height map 703.

In specific embodiments, the region of interest (e.g., zone of interest) may not be a contiguous volume but rather may be several disconnected volumes. The region of interest may be a collection of data rather than the physical space. For example, the region of interest may refer to specific portions of a 2D image, a point cloud, or a height map rather than the physical region in the environment. The stereo camera system may use the determined region of interest to make a region of interest filter to focus density estimates on relevant regions of the environment captured by the stereo camera.

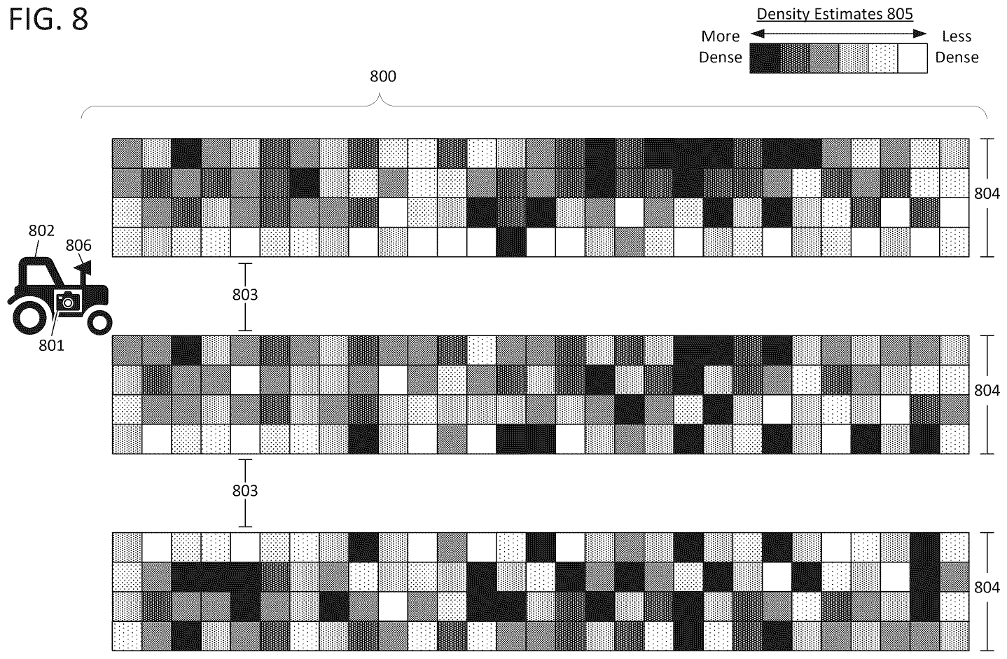

FIG. 8 provides an example of density map 800 of a field of crops in accordance with specific embodiments of the inventions disclosed herein. Stereo imaging system 801 may be mounted onto vehicle 802 that may travel along navigation rows 803 (e.g. paths) between crop rows 804. Each voxel of density map 800 may refer to a density estimate 805 for the corresponding real-world foliage in that volume. Stereo imaging system 801 may combine material density estimates 805 with a localization to create density map 800. Localization may be obtained from a GPS, IMU, or other positioning system. The density estimates 805 may be logged for each position and filtered (e.g., region of interest filter, semantic filter, foliage filter, biomass filter) to obtain density map 800 of the field. Density estimates 805 may be used to determine agricultural actions. For example, density estimates 805 may cause a control signal to be sent to actuator 806 (which may be part of stereo imaging system 801 or may be separate). Actuator 806 may perform an agricultural action in response to the control signal. For example, how much chemical (e.g., herbicide, pesticide) to spray at a location may be based on density map 800 and, accordingly, density estimates 805 may trigger a control signal to an actuator such as a nozzle to spray or more or less chemical.

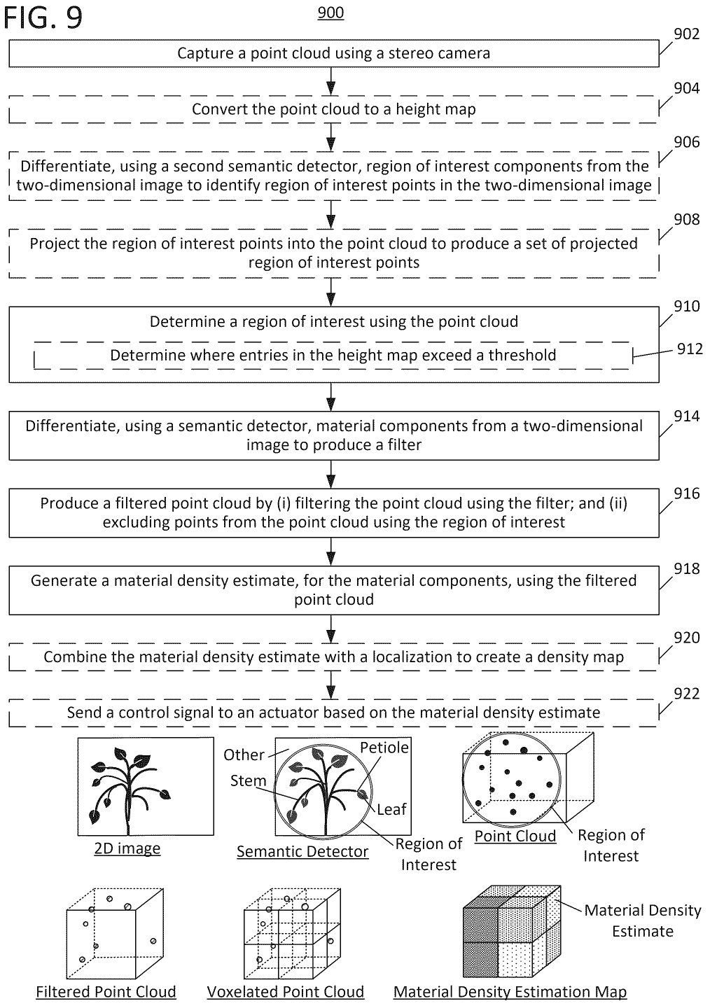

FIG. 9 provides an example of method 900 for generating a material density estimate in accordance with specific embodiments of the inventions disclosed herein. Method 900 may be computer-implemented. Method 900 may be implemented by a system including a pair of imagers, one or more processors, and one or more non-transitory computer-readable media. In specific embodiments, the system may also include an actuator and one or more localization sensors (e.g., IMU, GPS). Method 900 may be implemented by a system including a non-transitory computer-readable medium having instructions stored thereon, that when executed by one or more processors of a stereo imaging system cause the one or more processors to perform operations of method 900. Method 900 may be implemented by a system including means for performing the steps of method 900. Steps, or portions of steps, of method 900 may be duplicated, omitted, rearranged, or otherwise deviate from the form shown. Additional steps may be added to method 900. Steps, or portions of steps, of method 900 may be performed in series or parallel.

At step 902, a point cloud may be captured using a stereo camera. In specific embodiments, capturing the point cloud may be based on one or more 2D images captured by the stereo camera.

In specific embodiments, at step 904, the point cloud may be converted to a height map.

In specific embodiments, at step 906, region of interest components may be differentiated from the 2D image to identify region of interest points in the 2D image. The region of interest components may be differentiated using a second semantic detector (e.g., opposed to the semantic detector in step 914).

In specific embodiments, at step 908, the region of interest points may be projected into the point cloud (e.g., captured at step 902) to produce a set of projected region of interest points.

At step 910, a region of interest may be determined using the point cloud. In specific embodiments, determining the region of interest may use the height map (e.g., generated at step 904). In specific embodiments, determining the region of interest may use the set of projected region of interest points (e.g., produced at step 908). In specific embodiments, determining the region of interest may involve extending the region of interest from the ground up towards the set of projected region of interest points.

In specific embodiments and as part of determining the region of interest, at step 912, where entries in the height map (e.g., generated at step 904) exceed a threshold may be determined. In specific embodiments, some or all entries that meet or exceed the threshold may be determined to be part of the region of interest. In specific embodiments, some or all entries that are below the threshold may be determined to be outside of the region of interest.

At step 914, material components may be differentiated from a 2D image to produce a filter. The material components may be differentiated using a semantic detector. In specific embodiments, the 2D image may be captured by the stereo camera. In specific embodiments, the material components may be foliage components. In specific embodiments, the foliage components may be leaves and petioles but not stems. In specific embodiments, capturing the point cloud (e.g., step 902) may be based on the 2D image.

At step 916, a filtered point cloud may be produced by filtering the point cloud (e.g., captured at step 902) using the filter (e.g., produced at step 914) and by excluding points from the point cloud using the region of interest (e.g., determined at step 910).

At step 918, a material density estimate may be generated for the material components using the filtered point cloud (e.g., produced at step 916). In specific embodiments, generating the material density estimate may use a voxel map of the region of interest. In specific embodiments, the material density estimate may be a foliage density estimate.

In specific embodiments, at step 920, the material density estimate may be combined with a localization to create a density map. In specific embodiments the localization may be based on one or more localization sensors such as an IMU or GPS.

In specific embodiments, at step 922, a control signal may be sent to an actuator based on the material density estimate (e.g., generated at step 918). In specific embodiments, the actuator may perform an agricultural action in response to the control signal. In specific embodiments, the actuator may be a nozzle control system, and the agricultural action may be to adjust an amount of chemical that the nozzle sprays or a direction that the nozzle sprays. Accordingly, agricultural chemical application may be made more efficient with less waste.

At least one processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a DDR DRAM. The shared memory can be accessed by multiple channels. The non-transitory computer readable media can store data required for the execution of any of the methods disclosed herein, the instruction data disclosed herein, and/or the operand data disclosed herein. The computer-readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to cameras, any imager may be used. Similarly, although foliage and trees are generally discussed, the density of any grouping of material (e.g., produce in trees, leaves on vines, items on shelves, etc.) may be determined. Additionally, although chemical spray was used as an example for actuator actions, other actions may be taken based on foliage density. Foliage density calculations may also contribute to knowledge about plant health and yield predictions without a direct actuator action. These and other modifications and variations to the present invention may be practiced by those skilled in the art, without departing from the scope of the present invention, which is more particularly set forth in the appended claims.

What is claimed is:

1. A computer-implemented method comprising:
capturing a point cloud using a stereo camera;
determining a region of interest using the point cloud;
differentiating, using a semantic detector, material components from a two-dimensional image to produce a filter;
producing a filtered point cloud by (i) filtering the point cloud using the filter; and (ii) excluding points from the point cloud using the region of interest; and
generating a material density estimate, for the material components, using the filtered point cloud.

2. The computer-implemented method of claim 1, wherein:
generating the material density estimate uses a voxel map of the region of interest.

3. The computer-implemented method of claim 1, wherein:
the two-dimensional image is captured by the stereo camera.

4. The computer-implemented method of claim 1, further comprising:
converting the point cloud to a height map;
wherein the determining of the region of interest uses the height map.

5. The computer-implemented method of claim 1, further comprising:
differentiating, using a second semantic detector, region of interest components from the two-dimensional image to identify region of interest points in the two-dimensional image; and
projecting the region of interest points into the point cloud to produce a set of projected region of interest points;
wherein the determining of the region of interest uses the set of projected region of interest points and involves extending the region of interest from the ground up towards the set of projected region of interest points.

6. The computer-implemented method of claim 1, further comprising:
combining the material density estimate with a localization to create a density map.

7. The computer-implemented method of claim 1, further comprising:
sending a control signal to an actuator based on the material density estimate.

8. The computer-implemented method of claim 7, wherein:
the actuator performs an agricultural action in response to the control signal.

9. The computer-implemented method of claim 1, further comprising:
converting the point cloud to a height map;
wherein determining the region of interest comprises determining where entries in the height map exceed a threshold.

10. The computer-implemented method of claim 1, wherein:
the material components are foliage components; and
the material density estimate is a foliage density estimate.

11. The computer-implemented method of claim 10, wherein:
the foliage components are leaves and petioles but not stems.

12. The computer-implemented method of claim 1, wherein:
capturing the point cloud is based on the two-dimensional image.

13. One or more non-transitory computer-readable media storing instructions that, when executed by one or more processors, cause the one or more processors to conduct a method comprising:
capturing a point cloud using a stereo camera;
determining a region of interest using the point cloud;
differentiating, using a semantic detector, material components from a two-dimensional image to produce a filter;
producing a filtered point cloud by (i) filtering the point cloud using the filter; and (ii) excluding points from the point cloud using the region of interest; and
generating a material density estimate, for the material components, using the filtered point cloud.

14. The one or more non-transitory computer-readable media of claim 13, wherein:
generating the material density estimate uses a voxel map of the region of interest.

15. The one or more non-transitory computer-readable media of claim 13, the method further comprising:
converting the point cloud to a height map;
wherein the determining of the region of interest uses the height map.

16. The one or more non-transitory computer-readable media of claim 13, the method further comprising:
differentiating, using a second semantic detector, region of interest components from the two-dimensional image to identify region of interest points in the two-dimensional image; and
projecting the region of interest points into the point cloud to produce a set of projected region of interest points;
wherein the determining of the region of interest uses the set of projected region of interest points and involves extending the region of interest from the ground up towards the set of projected region of interest points.

17. The one or more non-transitory computer-readable media of claim 13, the method further comprising:
combining the material density estimate with a localization to create a density map.

18. The one or more non-transitory computer-readable media of claim 13, the method further comprising:
sending a control signal to an actuator based on the material density estimate.

19. The one or more non-transitory computer-readable media of claim 18, wherein:
the actuator performs an agricultural action in response to the control signal.

20. A stereo imaging system for detecting physical objects comprising:
a pair of imagers;
one or more processors; and
one or more non-transitory computer-readable media storing instructions that, when executed by the one or more processors, cause the stereo imaging system to conduct a method comprising:
capturing a point cloud using a stereo camera;
determining a region of interest using the point cloud;
differentiating, using a semantic detector, material components from a two-dimensional image to produce a filter;
producing a filtered point cloud by (i) filtering the point cloud using the filter; and (ii) excluding points from the point cloud using the region of interest; and
generating a material density estimate, for the material components, using the filtered point cloud.
